(19) United States
(12) Patent Application Publication
(10) Pub. No.: US 2022/0275785 A1
(43) Pub. Date: Sep. 1, 2022

(54) FLOATING VERTICAL-AXIS WIND TURBINE

(71) Applicant: Shaanxi Kerlimar Engineers Co., Ltd., Shaanxi Province (CN)

(72) Inventor: Ming Sun, Shaanxi Province (CN)

(73) Assignee: Shaanxi Kerlimar Engineers Co., Ltd., Shaanxi Province (CN)

(21) Appl. No.: 17/509,950

(22) Filed: Oct. 25, 2021

(30) Foreign Application Priority Data
Feb. 26, 2021 (CN) 202110222586.6

(51) Int. Cl. F03D 3/06; F03D 9/25; F03D 3/00; F03D 15/00; F03D 13/20; H02K 7/116; H02K 7/18

(52) U.S. Cl. CPC F03D 3/062; F03D 9/25; F03D 3/005; F03D 15/00; F03D 13/20; H02K 7/116; H02K 7/183; F05B 2240/211; F05B 2240/30; F05B 2260/30

(57) ABSTRACT

A floating vertical-axis wind turbine which uses a grid architecture design on whole is provided. Each blade is a closed body, the contour of which is designed according to hydrodynamics. During power generation, the blades are perpendicular to the ground. The impeller is provided with three cantilevers which extend from inside to outside to be connected to blades. A triangular grid structure is provided in the middle, and has an inner side connected with a transmission shaft sleeve which is arranged around an outer side of the tower. Bearings are arranged between the transmission shaft sleeve and the tower. When the impeller is rotated to drive the transmission shaft sleeve to rotate, the wind energy collected by the impeller is transmitted to a generator through an outer gear on the transmission shaft sleeve. The blade is of a hollow structure inside and is filled with helium bags.

### CROSS REFERENCE TO RELATED APPLICATION

This application claims the benefit and priority of Chinese Patent Application No. 202110222586.6, entitled “Floating Vertical-axis Wind Turbine” filed with the Chinese Patent Office on Feb. 26, 2021, the disclosure of which is incorporated by reference herein in its entirety as part of the present application.

### TECHNICAL FIELD

The present disclosure belongs to the technical field of wind power generation equipment, and specifically relates to a vertical-axis wind turbine which is of a grid frame structure and is designed with helium bags.

### BACKGROUND ART

At present, a wind turbine on a current wind power plant has giant blades, and outer diameters of blades increase constantly. The radius is now greater than 80 meters, which has an extremely high requirement for the intensity of the blades, so that the manufacture cost is extremely high, and it is very difficult to transport, install and maintain the wind turbine. A tower installed with blades and an impeller is as high as 160 meters or above, so its construction costs are apparently extremely high. Moreover, during the rotation of the impeller, the impeller will generate huge turbulence, causing huge resistance, and the wind power utilization rate is not high.

### SUMMARY

The present disclosure relates to a wind energy collection and power turbine perpendicular to the ground. The wind turbine of this disclosure solution is mainly composed of a tower, an impeller provided with floating blades and a flat grid frame structure, a grid member for hanging and fastening the impeller, and a generator.

The tower of this disclosure has a structure and function similar to that of a current horizontal axis wind turbine. The tower is installed with two bearings which are capable of rotating around the tower, and the upper bearing is connected with an upper grid member. The lower bearing is connected to a center grid member of the impeller. The lower bearing is connected with a transmission shaft sleeve. An external gear on the drive shaft sleeve outputs wind energy collected by the impeller to a gearbox, thereby further driving the generator to work.

The impeller of this disclosure is of a large-sized flat grid frame structure, and is composed of three parts. The grid frame structure (which is referred to as a lower grid member in this disclosure) is at a center of the impeller and has an inner side connected to the transmission shaft sleeve on an outer side of the tower. A bearing (which is referred to as the lower bearing in this disclosure) is arranged between the transmission shaft sleeve and the tower. Therefore, the transmission shaft sleeve can freely rotate around the tower. A gear is arranged on an outer side of the transmission shaft sleeve. When the impeller rotates to drive the drive shaft sleeve to rotate, the wind energy collected by the impeller is transmitted to the generator via the gear of the drive shaft sleeve.

The blades are arranged at an exterior of the impeller. Each blade is of a closed structure formed by one side being of an arc-shaped plate and the other side being of a flat straight plate. The closed structure is designed according to a lift structure of aerodynamics. When wind flows through the blades, outward tensions are generated by a flow velocity difference, which increases power output of the blades. Each blade is of a hollow structure and is filled with helium bags to generate buoyancy.

A middle part of the impeller is grid cantilevers. For small and medium-sized wind turbines, only one blade is provided at an outermost end of each cantilever. For large-sized and oversized wind turbines, two or more blades shall be provided. A middle blade supports cantilevers on both sides of the middle blade by its own buoyancy. The cantilever of the middle blade is connected with a respective cantilever of the center grid member via a hinge joint. When the blades need to be maintained, the blades can be pulled down to the ground by a rope, thereby facilitating for easy operation.

The upper part of this disclosure is the grid member for hanging and fastening the impeller, which extends from a top of the tower to the middle of the impeller all the time. The grid member is made of high-intensity light-weight steel or an aluminum alloy material, so as to meet the design requirements of high intensity and light weight. The grid structure has a geometric structure of an optimized triangular design, so that the whole grid member is firmer.

The architecture design of this disclosure is formed by the optimized triangular structure from the whole to the parts, so that the wind turbine becomes a firm whole. In this case that the cost is controllable, the anti-risk capacity is greatly improved, and a new economic solution is provided for enlargement of a wind turbine.

### BRIEF DESCRIPTION OF THE DRAWINGS

In order to describe the technical solutions in the embodiments of the present disclosure more clearly, drawings required to be used in the embodiments will be briefly introduced below. Obviously, the drawings in the illustration below are only to describe the embodiments of the present disclosure or the technical solutions in the existing art more clearly. Those of ordinary skill in the art also can acquire other drawings according to the provided drawings without doing creative work.

FIG. 1 is a front view of a vertical-axis wind turbine of the present disclosure.

FIG. 2 is a top view of a vertical-axis wind turbine of the present disclosure.

In the drawings: 1: inner cantilever; 2: upper bearing; 3: tower; 4: upper grid member; 5: hinge; 6: middle blade; 7: external blade; 8: generator; 9: lower bearing; 10: outer cantilever.

### DETAILED DESCRIPTION OF THE EMBODIMENTS

In order to make the technical solutions of the present disclosure better understood and implemented by those skilled in the art, the present disclosure is further explained in combination with specific embodiments below, but the embodiments are only used as describe the present disclosure, and are not intended to limit the present disclosure.

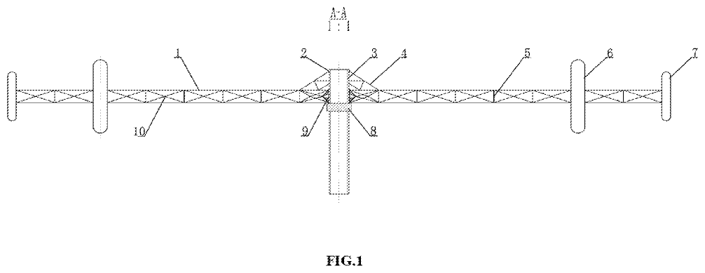

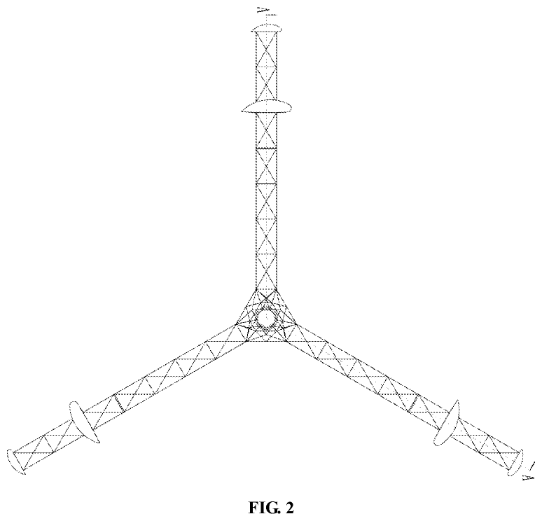

FIG. 1 to FIG. 2 show a wind energy collection and power turbine perpendicular to the ground. The wind turbine of this embodiment comprises a tower (3), an impeller being of a flat grid frame structure, a grid member (4) for hanging and fastening the impeller, and a generator (8) which is mounted onto the tower.

After the wind turbine is installed completely, pneumatic blades can realize the absorption of wind energy though pneumatic profiles. Due to the floating blades, cantilevers of the impeller can become longer, so that the output power of the impeller is greatly enhanced.

Under the pushing of wind, the impeller rotates around the tower (3) by virtue of the supporting of two bearings. A center grid member of the impeller pushes a transmission shaft sleeve to rotate. An external gear of the drive shaft sleeve outputs wind energy collected by the impeller to a gearbox, thereby further driving the generator to work.

In order to improve the wind resistance and the stability of this embodiment, the impeller is designed to be of a large-sized flat grid frame structure. When multiple blades are provided, each middle blade has relatively large volumes and generates high buoyancy to support cantilevers on both sides of each middle blade. When the impeller rotates, outermost blades (7) have high speed, so that the outermost blades have relatively small volume to reduce the resistance.

Preferably, there are three cantilevers in this embodiment, which are uniformly arranged outwards and evenly spaced around the center of the tower, so that the number of blades is generally three or a multiple of three.

When two or more blades are mounted on each cantilever, the cantilever is divided into an inner part and an outer part. The inner cantilever is integrated with the center grid member, and the outer cantilever is integrally connected with the middle blade. The inner and outer cantilevers are connected via a hinge (5) joint. When the blade needs to be maintained, the outer cantilever can be pulled down to the ground by a rope to facilitate the operation.

In this embodiment, in order to create good conditions for implementation, the grid member uses a light-weight and high-intensity material and is easy to install. The cantilever can be designed into a plurality of small components to facilitate manufacture, transportation, installation and maintenance.

The inside of the tower is the same as that of an existing wind power tower, where an elevator or other facilities can be installed.

The key protection of the present disclosure:

The upper part of this embodiment is the grid member for hanging and fastening the impeller, and the grid member extends from the top of the tower to the middle of the impeller all the time. The grid member is made of high-intensity and light-weight steel or an aluminum alloy material to meet the design requirements of high intensity and light weight. The geometric structure of the grid structure employs an optimized triangular model, so that the whole main structure is also triangular, and the whole grid frame structure is firmer, which also creates advantages for manufacturing large-sized wind turbines.

Each cantilever of the impeller of this embodiment is designed into an inner part and an outer part. The inner cantilever and the outer cantilever are connected via a hinge joint. In this way, the outer cantilever and the blade can be pulled down to the ground position by the rope to facilitate maintenance.

The blades of this embodiment are of a hollow design and are filled with helium bags. The blades produce buoyancy to support the cantilevers on both sides. This design creates highly advantageous conditions for extension of the cantilever of the impeller, and a new way is designed for enlargement and excessive enlargement of the wind turbine.

Contents that are not described in detail in the present disclosure are the existing art.

The above descriptions are only the preferred embodiments of the present disclosure, and are not intended to limit the present disclosure. Any modifications, equivalent replacements and improvements that are made within the spirit and principle of the present disclosure shall fall within the protection scope of the present disclosure.

What is claimed is:

1. A wind energy collection and power generation device perpendicular to the ground, comprising a tower (3), an impeller framework being of a flat grid frame structure, blades with buoyancy, a grid member (4) for hanging and fastening the impeller framework, and a generator (8) which is mounted onto the tower.

2. The device according to claim 1, wherein the tower (3) has a same shape as that of a tower of an existing horizontal axis wind turbine; the tower is provided with an upper bearing and a lower bearing which are capable of rotating around the tower, and the upper bearing (2) is connected with the grid member (4) and used to hang the impeller.

3. The device according to claim 1, wherein the impeller is of a large-sized grid frame structure and a network structure is provided in a center of the impeller and has an inner side connected to a transmission shaft sleeve which is arranged around an outer side of the tower; a lower bearing (9) is arranged between the transmission shaft sleeve and the tower, such that the transmission shaft sleeve is capable of freely rotating around the tower; a gear is sleeved on the transmission shaft sleeve; and upon the impeller rotating to push the transmission shaft sleeve to rotate, the wind energy collected by the impeller is transmitted to the generator via the gear of the transmission shaft sleeve.

4. The device according to claim 1, wherein the impeller is provided at an outer part thereof with three cantilevers which extend outwards for being connected to the blades; one, two or more blades are provided on each of the cantilevers; the blades each are of a closed body formed by an arc-shaped plate located at an outer side and a flat straight plate located at an inner side; the blades are designed according to a lift structure of aerodynamics; when wind flows through each blade, an outward tension is generated by a flow velocity difference to increase power output of the blade; in a case that each of the cantilevers is provided with two blades, an inner blade (6) of the two blades arranged have relatively large volume for facilitating being filled with more helium bags so as to support two side parts of a corresponding cantilever divided by the inner blade through buoyancy; and in a case that more blades are provided for higher thrust, a layout of the blades is done in the same manner.

5. The device according to claim 1, wherein the grid member (4) for hanging and fastening the impeller is arranged at an upper part of the device, and extends from a top of the tower to a middle of the impeller; the grid member (4) is made of high-intensity and light-weight steel or an aluminum alloy material or other equivalent materials to meet design requirements of high intensity and light weight; the grid member has a geometric structure of an optimized triangular structure, such that the grid member is firmer.

6. The device according to claim 1, wherein the device is formed by the optimized triangular structure from global to local, so that the device is a firm whole; and in a case that a cost is controllable, anti-risk capacity is greatly improved, and a new economic solution is provided for enlargement of the device.

7. The device according to claim 1, wherein the cantilevers are designed to be as long as possible for increasing power of the generator, and each are divided into an inner cantilever (1) and an outer cantilever (10); and the outer cantilever and the inner cantilever are connected via a hinge (5), such that the outer cantilever can be pulled down by a rope to fall to a ground, which greatly facilitates maintenance of the blades
